(19) United States
(12) Patent Application Publication
(10) Pub. No.: US 2012/0234594 A1
(43) Pub. Date: Sep. 20, 2012

(54) Portable Electrical Receptacle Device and Method

(76) Inventor: Alan Peterson, Naugatuck, CT (US)

(21) Appl. No.: 13/423,724

(22) Filed: Mar. 19, 2012

Related U.S. Application Data
(60) Provisional application No. 61/454,039, filed on Mar. 18, 2011.

(51) Int. Cl. H01R 13/502

(52) U.S. Cl. 174/560

(57) ABSTRACT

An electrical power distribution device and method is provided and includes a device housing, wherein the device housing is shaped to define a device cavity and includes a first housing portion and a second housing portion, wherein the first housing portion is connected to the second housing portion via a hinge member such that the first housing portion and the second housing portion rotate relative to each other between a first configuration and a second configuration, and wherein the device cavity is configured to allow the device housing to wrap around a support structure; a connecting member; a power connection cord; and at least one electrical receptacle associated with the device housing and electrically connected with the power connection cord.

### RELATED APPLICATIONS

This application claims the benefit of the filing date of U.S. Provisional Patent Application Ser. No. 61/454,039 filed Mar. 18, 2011 and titled “Portable Electrical Power Distribution Device and Method,” the contents of which are incorporated by reference herein in its entirety.

### FIELD OF THE INVENTION

This invention relates generally to a portable device for distributing power remotely from a power source and more particularly to a portable power distribution device that is mountable on poles and other supporting structures.

### BACKGROUND OF THE INVENTION

Portable shelters that are used for events, such as tents used for outdoor weddings, parties, etc., are well known and typically have a plurality of poles to support the structure. As these events may be held during both daytime and nighttime portable AC power must be distributed throughout the structure to supply power to various electrical equipment, such as lighting, sound amplifiers, musical instruments and cooking instruments. Typically, this AC power is distributed via power distribution devices, such as extension cords with multi-tap ends, common quad and duplex outlet boxes with pigtails, power strips and/or surge protector strips. As these power distribution devices must be anchored or fastened to nearby structures to prevent them from being disconnected from the AC power supply, they are typically fastened to a structure (such as a support pole) via various devices, including duct tape, tie wrap and bungee cords. Not only is this type of configuration undesirable due to its unpleasing aesthetic appearance, it is also undesirable because it is result in damage to the electrical equipment, as well as being labor intensive and unsafe.

### BRIEF SUMMARY OF THE INVENTION

An electrical power distribution device is provided and includes a device housing defining a device cavity and having a first housing portion movably connected to a second housing portion via a hinge member, wherein the first housing portion and second housing portion are configurable between a first configuration and a second configuration; a power connection cord; and at least one electrical receptacle, wherein the at least one electrical receptacle is associated with the device housing and electrically connected with the power connection cord.

Moreover, an electrical power distribution device is provided and includes a device housing, wherein the device housing is shaped to define a device cavity and includes a first housing portion and a second housing portion, wherein the first housing portion is connected to the second housing portion via a hinge member such that the first housing portion and the second housing portion rotate relative to each other between a first configuration and a second configuration, and wherein the device cavity is configured to allow the device housing to wrap around a support structure; a connecting member; a power connection cord; and at least one electrical receptacle associated with the device housing and electrically connected with the power connection cord.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a top down view of an electrical power distribution (EPD) device, in accordance with one embodiment of the present invention.

FIG. 2A is one embodiment of a top down view of a wire harness used in the EPD device of FIG. 1 illustrating the electrical connectivity of the EPD device of FIG. 1.

FIG. 2B is a side perspective view of the wire harness of FIG. 2A.

FIG. 3 is an enlarged side isometric view of the hinge member of the EPD device of FIG. 1.

FIG. 4 is an angled top down isometric view of the electrical power distribution device of FIG. 1.

FIG. 5 is an enlarged top down sectional view of the EPD device of FIG. 1, showing one embodiment of the latching member.

FIG. 6A is a top down view of the latching member of FIG. 5.

FIG. 6B is a side view of the latching member of FIG. 5.

FIG. 6C is a side isometric view of the handle catch of the latching member of FIG. 5.

FIG. 7 is a block diagram illustrating a method for fabricating the EPD device of FIG. 1, in accordance with one embodiment of the present invention.

FIG. 8 is a block diagram illustrating a method for implementing the EPD device of FIG. 1, in accordance with one embodiment of the present invention.

FIG. 9 is a side perspective view of the EPD device of FIG. 1, being implemented with a pole structure, in accordance with one embodiment of the present invention.

FIG. 10 is a top down perspective view of an EPD device utilizing receptacle/fixture modules, in accordance with another embodiment of the present invention.

FIG. 11 is a top down side isometric view of a receptacle/fixture module for the electrical power distribution device of FIG. 10.

FIG. 12 is a top down side isometric view of an additional embodiment of the power receptacle module of FIG. 11.

FIG. 13 is a top down isometric view of the EPD device utilizing receptacle/fixture module of FIG. 12, in accordance with another embodiment of the present invention.

FIG. 14 is a top down side perspective view of the EPD device of FIG. 1 having a device cavity configured in an octagonal shape.

FIG. 15 is a side view of the EPD device of FIG. 14 attached to a pole.

FIG. 16 is a side isometric view of a EPD device having a mounting bracket for attaching other devices, in accordance with an additional embodiment.

### DETAILED DESCRIPTION OF THE INVENTION

As disclosed herein with regards to an exemplary embodiment, an electrical power distribution device is disclosed, wherein the electrical power device is portable, easy to use and adjustably and removably mountable to a support structure, such as a pole having various shapes. For example, the electrical power device may be mounted to a mounting structure, such as a pole, that is cylindrical in shape, rectangular in shape and/or triangular in shape. Additionally, some embodiments of the electrical power device may include a plurality of power receptacles (AC and/or DC) that are connected to a power supply in a parallel configuration. As discussed hereinafter, the EPD device includes a hinged ring and connecting system (such as a latch mounting system) to allow for easy mounting onto a pole without tools. This hinged ring and connecting system also allows for easy removal. The fixtures and other electrical components/connections are encapsulated in an insulating material, such as urethane or other material suitable to the desired end purpose.

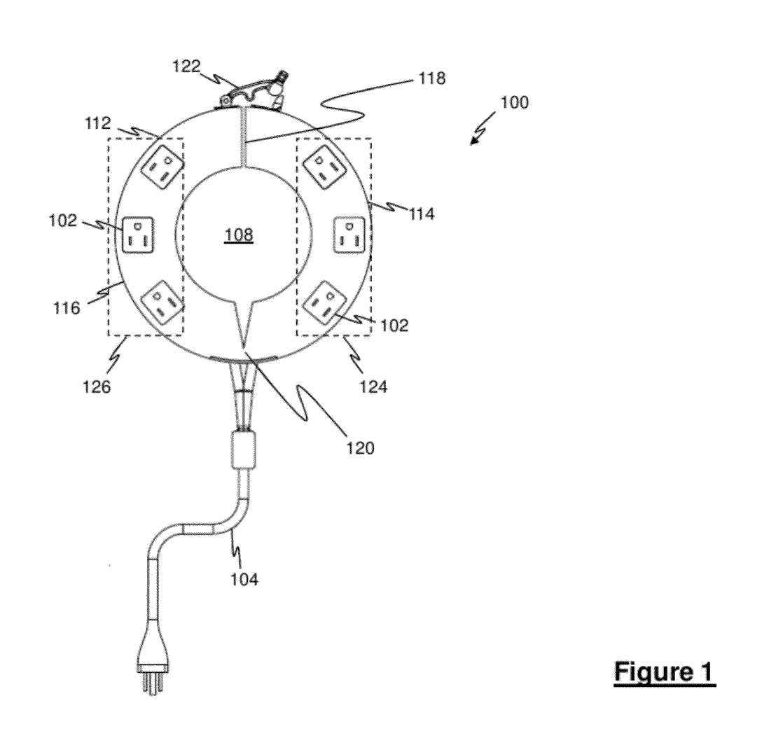

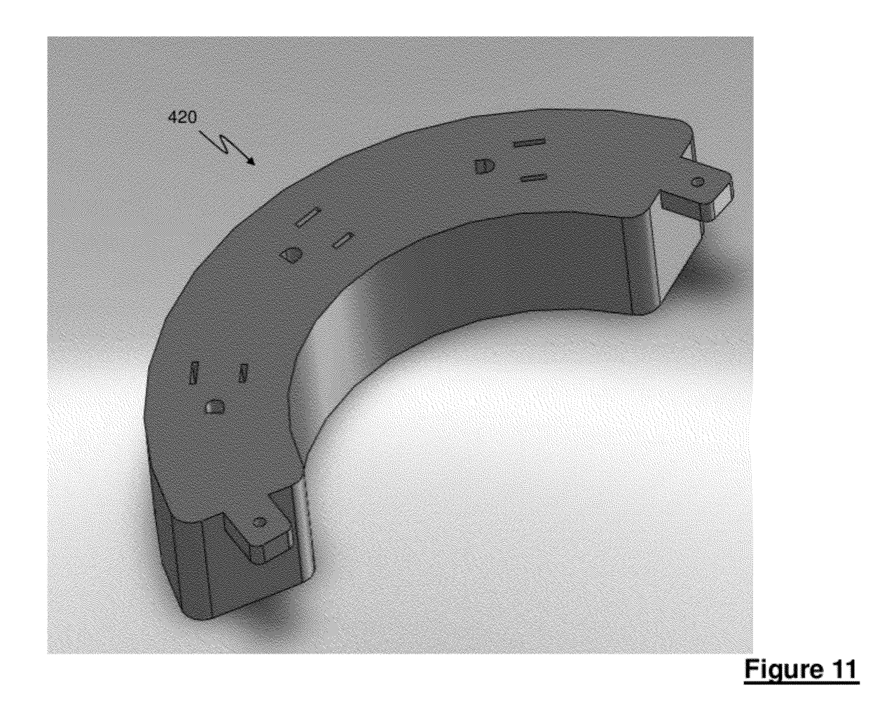

Referring to FIG. 1A, an exemplary embodiment of the electrical power distribution device 100 is shown and may include one or more electrical receptacles 102 (such as electrical plugs, or fixtures, such as light sockets as shown in FIGS. 11-14) connected with a power cord 104 having a cord plug 105, wherein at least a portion of the one or more electrical plug receptacles 102 are connected with each other in a parallel configuration (Although a series configuration may be used if desired). In accordance with the present invention, the one or more electrical receptacles 102 may include one type of plug receptacle or multiple types of plug receptacles. For example, the one or more electrical receptacles 102 may include only one type of plug receptacle (such as NEMA 5-15 or other types as desired) or the one or more electrical receptacles 102 may include multiple types of plug receptacles (such as three NEMA 5-15 plug receptacles and three NEMA 5-20 plug receptacles or other types as desired). It is also contemplated that the EPD device 100 may include one or more plugs (i.e. male type plugs) to allow a female end of an extension cord to connect to the electrical power distribution device 100. Moreover, it should be appreciated that although the power cord 104 is configured as a Y-cable type power cord, it is contemplated that any type of power cord configuration may be used as desired. For example, a straight cable may be used or the power cord may be removable, or multiple cords may be used. Additionally, it is contemplated that in one embodiment, the EPD device 100 may include a power receptacle built into the EPD device 100 and connected to the one or more electrical receptacles 102. This may be used in place of or in addition to the power cord 104. This would advantageously allow an extension cord to be connected (either male or female end depending on the power receptacle) directly to EPD device 100 while the other end of the extension cord is connected to a power source.

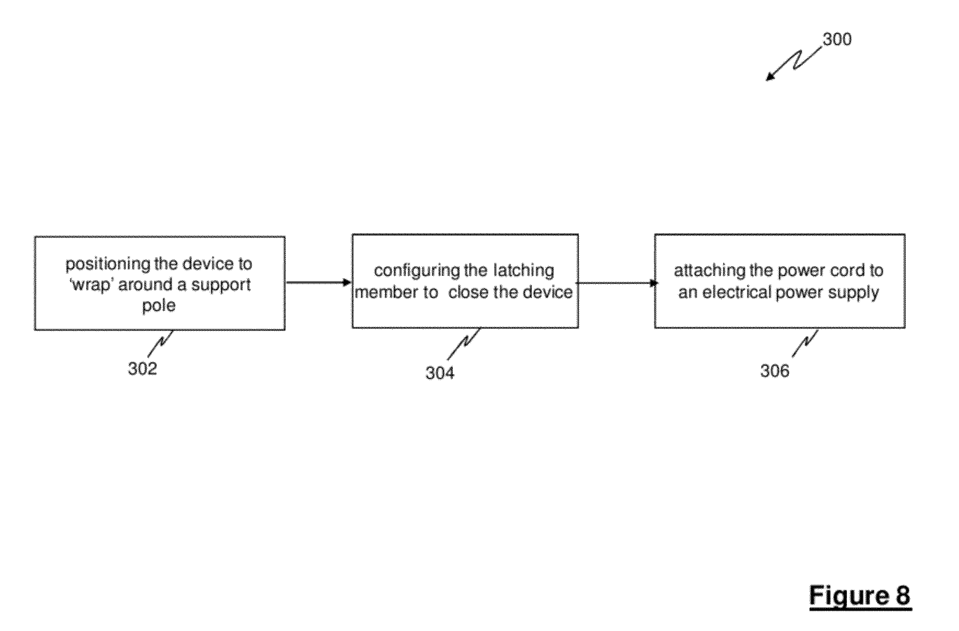

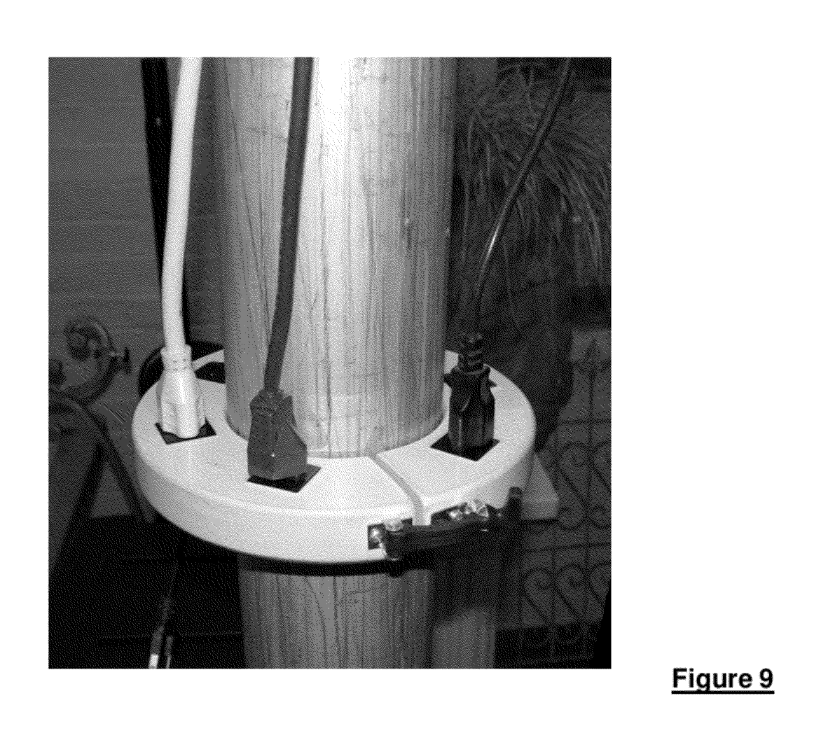

It is contemplated that each of the one or more electrical receptacles 102 and/or one or more plug outlets may be removable and/or replaceable so that a user can configure the electrical power distribution device 100 as they desire. This is discussed further hereinafter with regards to FIGS. 9-12. In accordance with one embedment of the invention, the electrical power distribution device 100 may be substantially circular (cylindrical) in shape and defines a device cavity 108 which is configured to contain a portion of a structure pole where the EPD device 100 connects to the structure pole by “wrapping” or encircling the pole and connecting the EPD device 100 closed (See FIG. 8). It should be appreciated that although the electrical power distribution device 100 and/or the device cavity 108 is shown as being substantially circular (cylindrical) in shape, the electrical power distribution device 100 and/or the device cavity 108 may any shape desired, such as for example square (rectangular), circular, triangular, octagonal, star shaped, etc. . . .

It is further contemplated that an insert may be included to securingly fit within the device cavity 108 to allow the EPD device 100 to be attached to poles that having different sizes and/or different shapes than the device cavity 108, wherein the insert would snugly fit inside of the device cavity to configure the device cavity to a different size and/or shape. For example, if the device cavity 108 is round in shape, but the pole the EPD device 100 is to be connected to is rectangular in shape, an insert that defines a rectangular insert cavity could be used where the outer portion of the insert is round in shaped to fit the inside of the device cavity 108 and the insert cavity is rectangular shaped to fit the support pole. Additionally, a textured surface or textured pads may be included and located on the surface of the EDP device 100 that defines the device cavity 108 to limit or prevent the EDP device 100 from sliding down the pole if the surface of the pole is smooth.

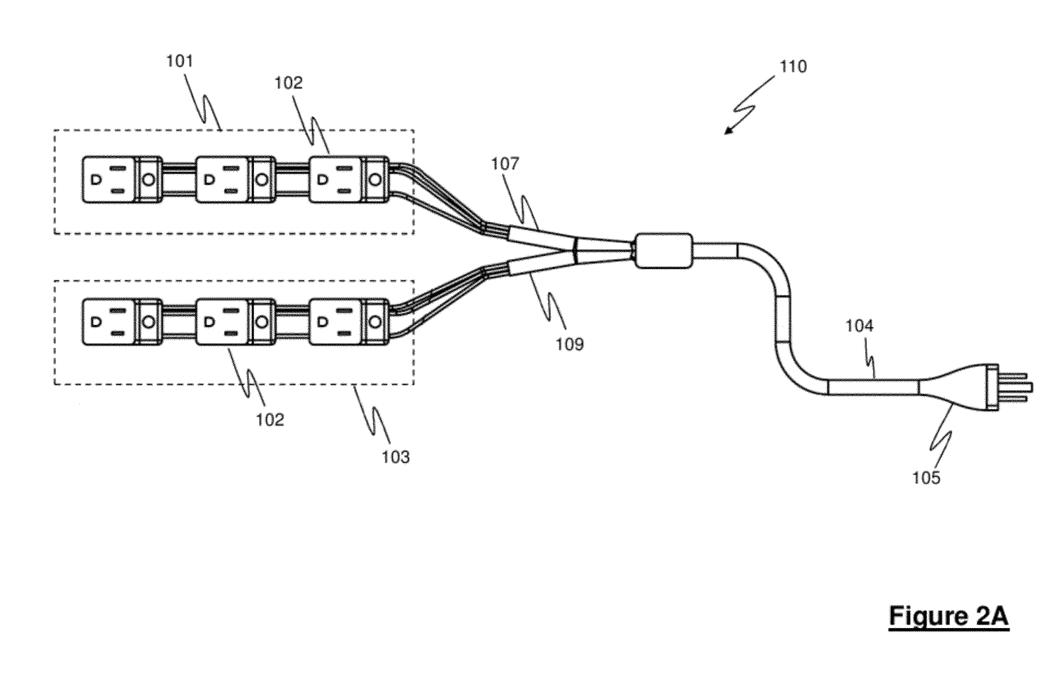

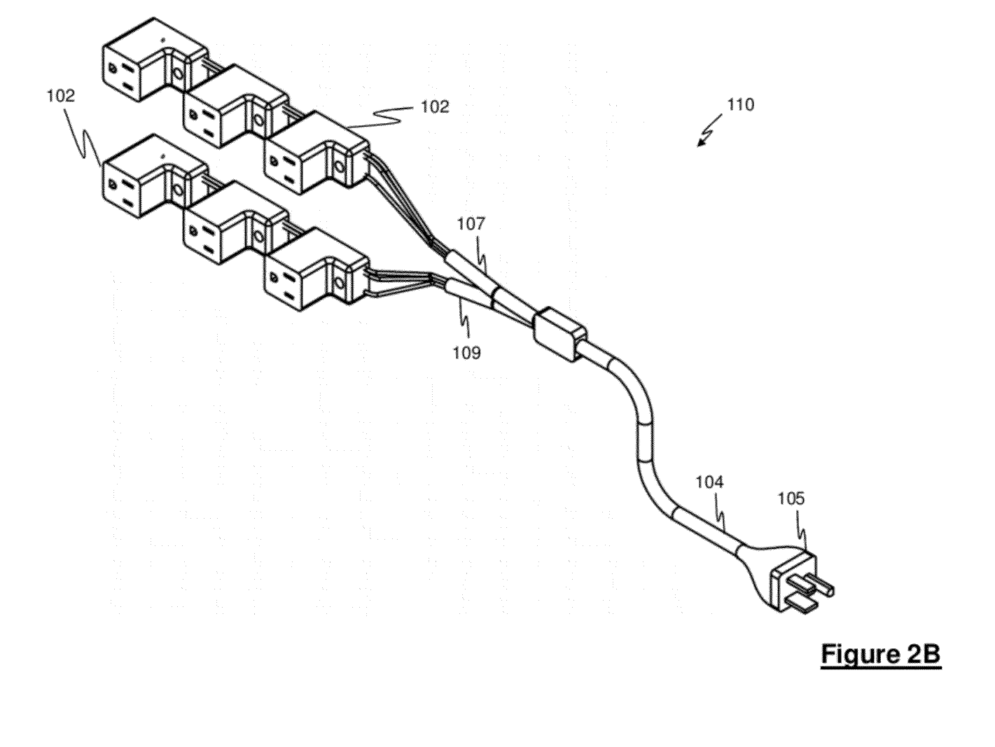

As can be seen in FIG. 2A and FIG. 2B, the electrical receptacles 102 divided into a first receptacle group 101 and a second receptacle group 103, where the first receptacle group 101 is connected to the power cord 104 via a first cord leg 107 and the second receptacle group 103 is connected to the power cord 104 via a second cord leg 109. This “wire harness” 110 is then disposed in a device enclosure 112 to electrically isolate the one or more electrical receptacles 102 from each other and from a user, where the power cord 104 is left to extend from the casing to allow the power cord 104 to be connected to a power supply. It should be appreciated that each “leg” of the power cord 104 is connected to the cord plug 105 such that when the cord plug 105 is connected to a power source, both legs of the power cord 104 receives power from the power source.

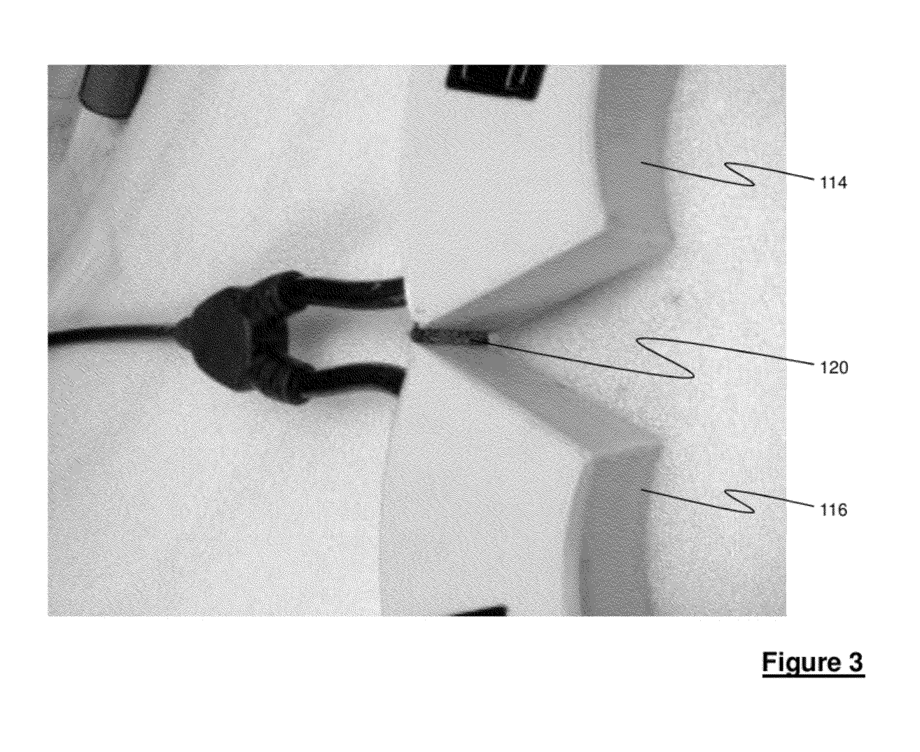

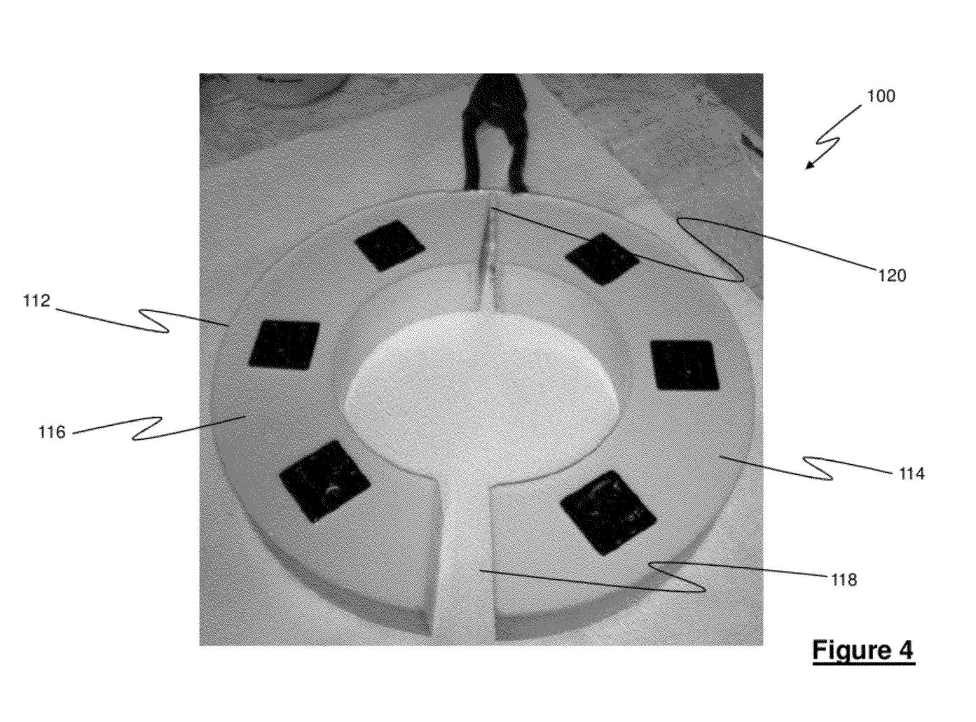

In accordance with one embodiment of the invention, the device enclosure 112 is preferably formed using a liquid urethane material molded around the wire harness 110. However, other types of enclosures 112 (either molded or mechanically constructed type enclosures) may be used as desired and may be constructed from any type of material suitable to the desired end purpose, such as aluminum and/or plastic enclosures. By way of example and not limitation, the enclosure may be molded from a different material than liquid urethane or the enclosure may be constructed from metal and/or plastic pieces held together via a mechanical means, such as screws, snaps, pins, etc. . . . As shown, the enclosure 112 is substantially circular (cylindrical) in shape and may be formed by a first half circle 114 (half cylinder) and a second half circle 116 (half cylinder), where the first half circle 114 and the second half circle 116 are not attached on one side to form an opening 118 and connected to each other on an opposing side by a hinge member 120 (see FIG. 3 and FIG. 4), where the hinge member 120 is configured to allow the first half circle 114 and second half circle 116 to rotate relative to each other.

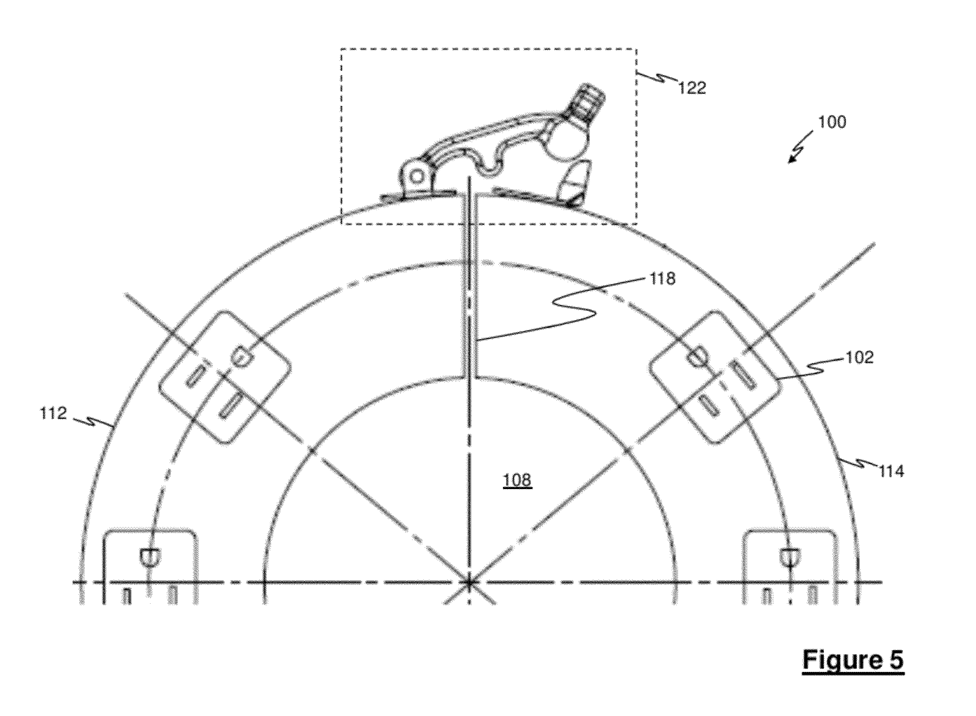

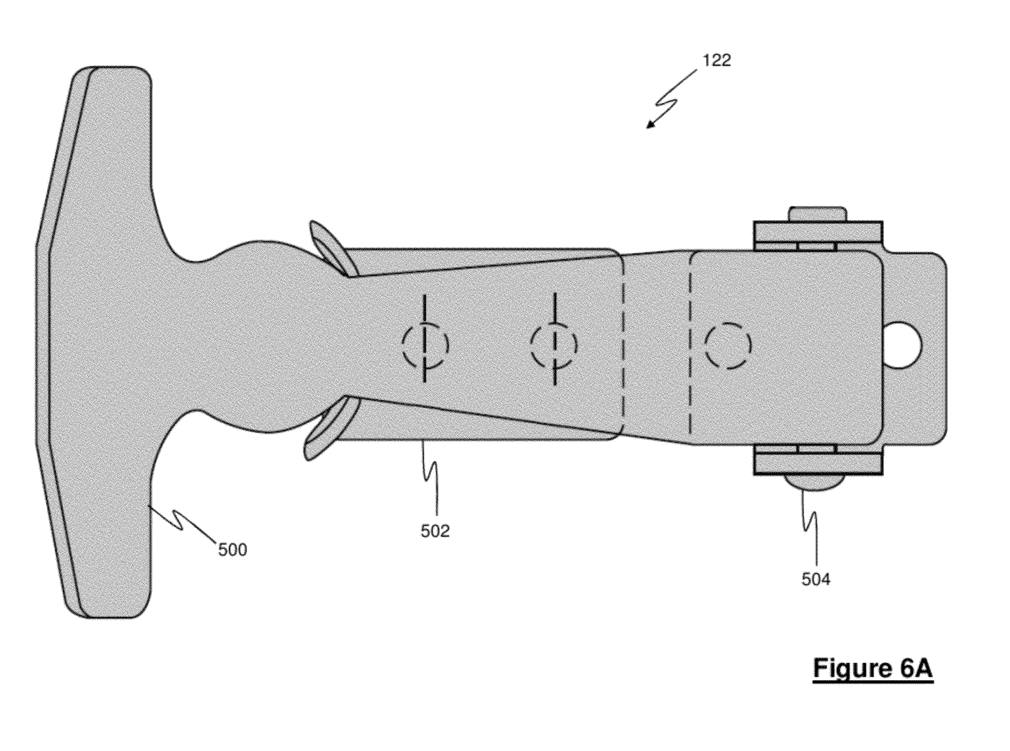

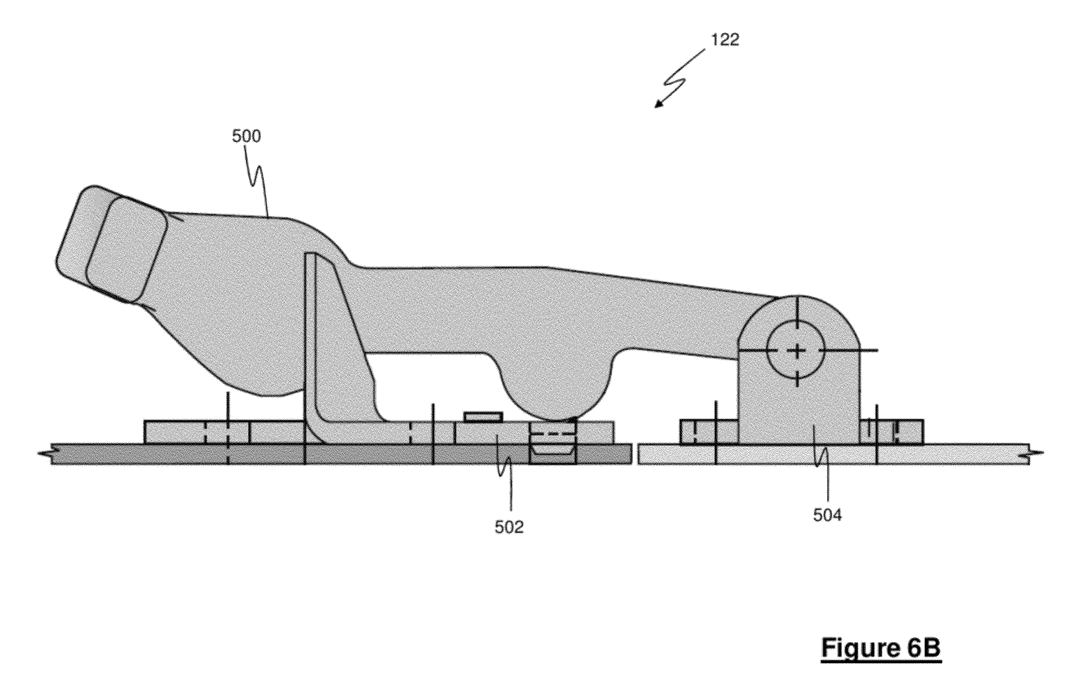

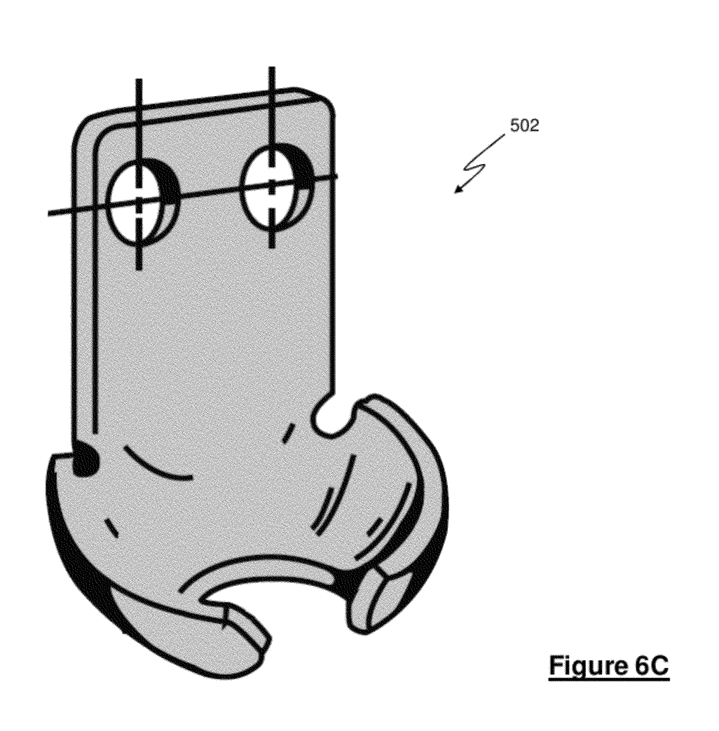

Referring to FIG. 1 and FIG. 5, one embodiment of a connecting member 122 is provided and shown as a latching member 122 located adjacent the opening 118 to allow the device enclosure 112 to securely latch together. One embodiment of the latching member 122 is shown in FIG. 6A, FIG. 6B and FIG. 6C, where the latching member 122 includes a locking handle 500 and a handle catch 502, where the locking handle 500 includes a handle mounting base 504 and configured such that the locking handle 500 and handle mounting base 504 is rotatable relative to each other. As used herein, the handle mounting base 504 is mounted to the first half circle 114 proximate the opening 118 such that the locking handle 500 rotates relative to the handle mounting base 504 to extend over the opening 118. The handle catch 502 is mounted to the second half circle 116 proximate the opening 118 such that when the locking handle 500 rotates to extend over the opening 118, the locking handle 500 and the handle catch 502 engage to be securely associated with each other. In one embodiment, the locking handle 500 is constructed from a resilient material (such as rubber) and is stretched to engage the handle catch 502. In another embodiment, the locking handle 500 is simply snapped into the handle catch 502 to engage the handle catch 502. It should be appreciated that although the device enclosure 112 is shown as being held together with a latching type device 122, it is contemplated that the connecting member 122 may be any type of device that can be used to hold the device enclosure 112 together may be used, such as clip, a magnet, etc. . . .

Referring again to FIG. 1, in one embodiment of the invention one side of the device enclosure 112 hosts a first plurality of plug receptacles 124 and the opposing side of the device enclosure 112 hosts a second plurality of plug receptacles 126. The first plurality of plug receptacles 124 are configured to be connected to each other in a parallel fashion (or if desired in a series fashion) and the second plurality of plug receptacles 126 are configured to be connected to each other in a parallel fashion (or if desired in a series fashion). Additionally, first plurality of plug receptacles 124 and the second plurality of plug receptacles 126 are connected to power cord 104. This configuration allows the first half circle 114 (half cylinder) and second half circle 116 (half cylinder) to rotate about the hinge member 120 relative to each other without disturbing the electrical connection of each of the one or more plug receptacles 102

In accordance with one embodiment of the invention, The EPD device 100 is made in a multi-step manufacturing process, which uses a casting mold. The molds are preferably cut in a fashion to allow a two part liquid urethane (or other suitable material) to be poured around the lower part of the electrical fixtures in a way that encapsulates the wiring and a portion of the electrical components. Two inserts (such as Teflon inserts) may be placed in the mold during the pouring process to allow for the splitting (i.e. opening) of the finished product. On the front side of the mold, the Teflon inserts allows for the complete separation of the opening. On the back side of the mold, the Teflon insert is placed with a slot to hold the inserted strap which acts as the hinge member 120. It should be appreciated that the hinge member may be attached (via screw, clip, adhesive, etc.) to the first half circle 114 (half cylinder) and/or the second half circle 116 and/or the hinge member 120 may be simply be encapsulated in the urethane to become an integral part of the finished product allowing for easy opening and closing of the product during use. It should be further appreciated that the hinge member 120 is preferably constructed from a pliable material which includes webbing and a polymer coating. One such example is a Biothane® strap. However, it is contemplated that any suitably strong pliable material could be used for the hinge member 120, such as a polypropylene, nylon, etc.

The electrical fixtures 102 may include any electrical fixtures suitable to the desired end purpose, such as NEMA 5-15R receptacles and/or floodlight/halogen lighting fixtures. The electrical fixture/wire is mounted on a separate pouring jig that is then bolted in place on the mold. With the pouring jig mounted on the mold the two part liquid urethane is poured into the mold. Once the urethane has hardened the pouring jig is un-bolted and the EPD device 100 (i.e. the cast ring with the encapsulated electrical fixtures 102, wiring harness 110 and strap hinge 120) is removed from the mold. The latching member 122 is then attached to the front of the EPD device 100 as discussed hereinbefore. It is contemplated that the latching member 122 may be attached to the EPD device 100 via any method suitable to the desired end purpose, such as adhesive, screws, clips, snaps, etc.

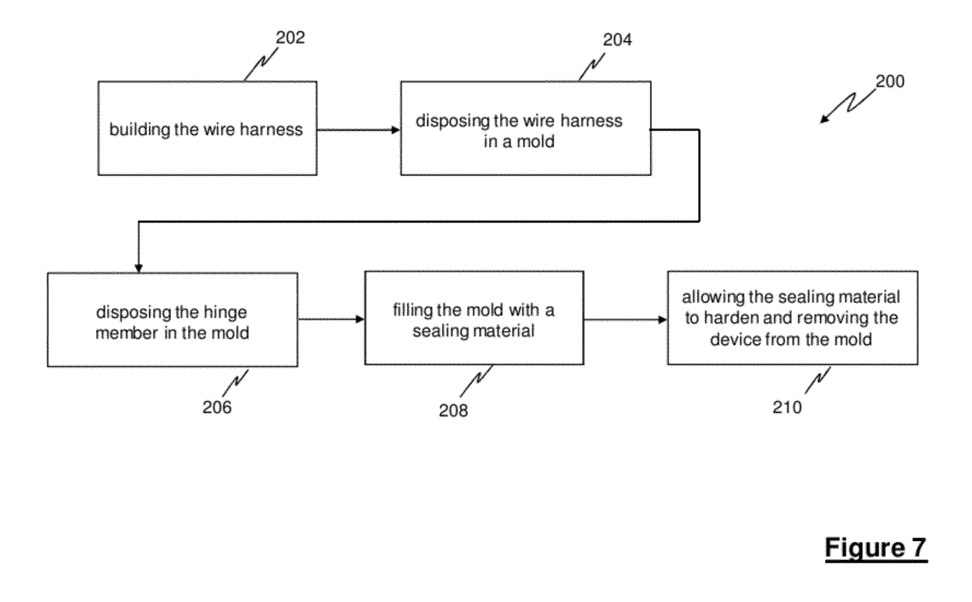

Referring to FIG. 7, an operational block diagram illustrating one embodiment of a method 200 for fabricating the electrical power distribution device 100 is shown and includes building the wire harness 110 to include a power cord 104, an electrical receptacle 102 (and/or outlet and/or fixture) to be configured as discussed hereinabove, as shown in operational block 202. When the wire harness 110 is complete, the wire harness 110 is disposed in a predetermined mold (such as an aluminum mold), as shown in operational block 204, which defines the shape of the electrical power distribution device 100. The method 200 further includes disposing hinge member 120 within the mold, as shown in operational block 206, filling the mold with a sealing material, such as liquid urethane, to completely cover the wires of the wire harness 110, while leaving the face of the plug receptacle 102 and/or outlet exposed, as shown in operational block 208. The material is allowed to harden and the device 100 is removed from the mold and finalized (cleaned, de-burred, sanded, attached latching member 122, etc.) for distribution, as shown in operational block 210.

Referring to FIG. 8, an operational block diagram illustrating one embodiment of a method 300 for implementing the electrical power distribution device 100 is shown and includes positioning the electrical power distribution device 100 such that the electrical power distribution device 100 ‘wraps’ around a support pole, where the support pole is positioned within the device cavity 108, as shown in operational block 302. If the support pole is shaped differently or smaller than the device cavity 108, then an insert may be used to adjust the shape and/or size of the device cavity 108 relative to the support pole. The latching member 122 is then configured to close the electrical power distribution device 100 (i.e. enclose the device cavity 108) thus snugly mounting the electrical power distribution device 100 to the support pole, as shown in operational block 304. The power cord 104 is then attached to a power supply, as shown in operational block 306, and electrical equipment can then be plugged into the electrical power distribution device 100 to receive power, as shown in FIG. 9.

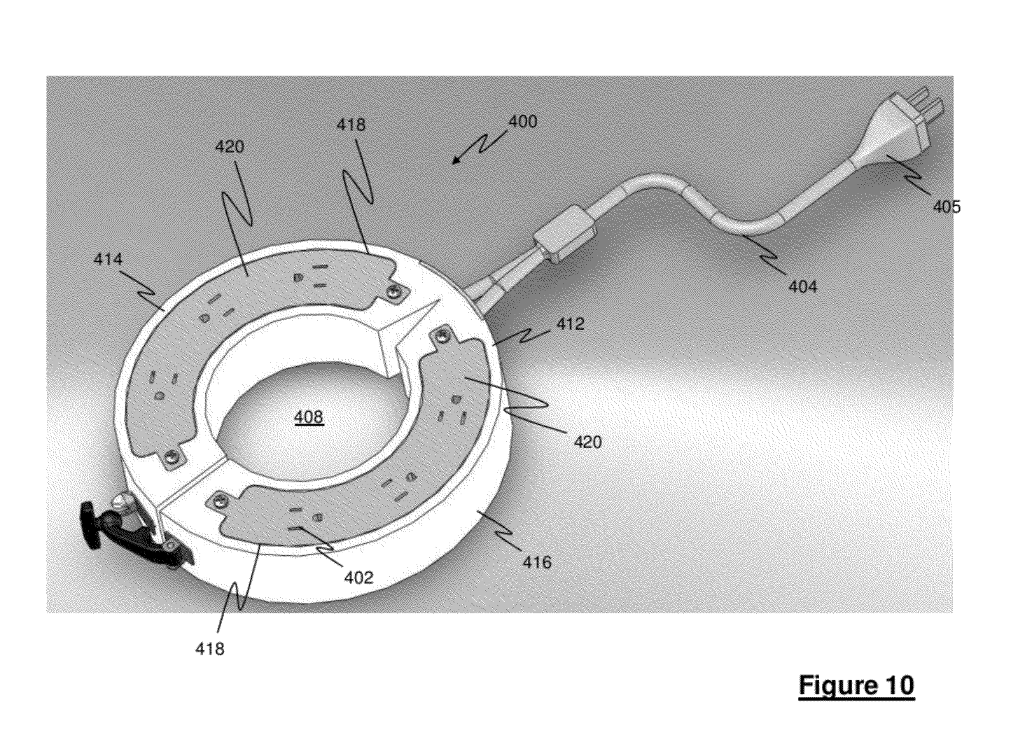

In accordance with another embodiment of the invention, an EPD device 400 is provided and is shown in FIG. 10 and FIG. 11. In similar fashion to the previous embodiments, the enclosure 412 is substantially circular (or cylindrical) in shape and may be formed by a first half circle 414 (half cylinder) and a second half circle 416 (half cylinder) which may be associated with each other and attached to a pole as described above. It should be appreciated that the first half circle 414 and/or second half circle 416 may include one or more replaceable and/or removable receptacle/fixture modules 420. In this embodiment, the EPD device 400 may include device module cavity in at least one of the first half circle 414 and the second half circle 416, where the device module cavity is shaped and configured to contain a receptacle/fixture module 420. The receptacle/fixture modules 420 may be securely contained within the device module cavity via any securing means and/or method suitable to the desired end purpose, such as screws, clips, snaps, friction fit, etc.

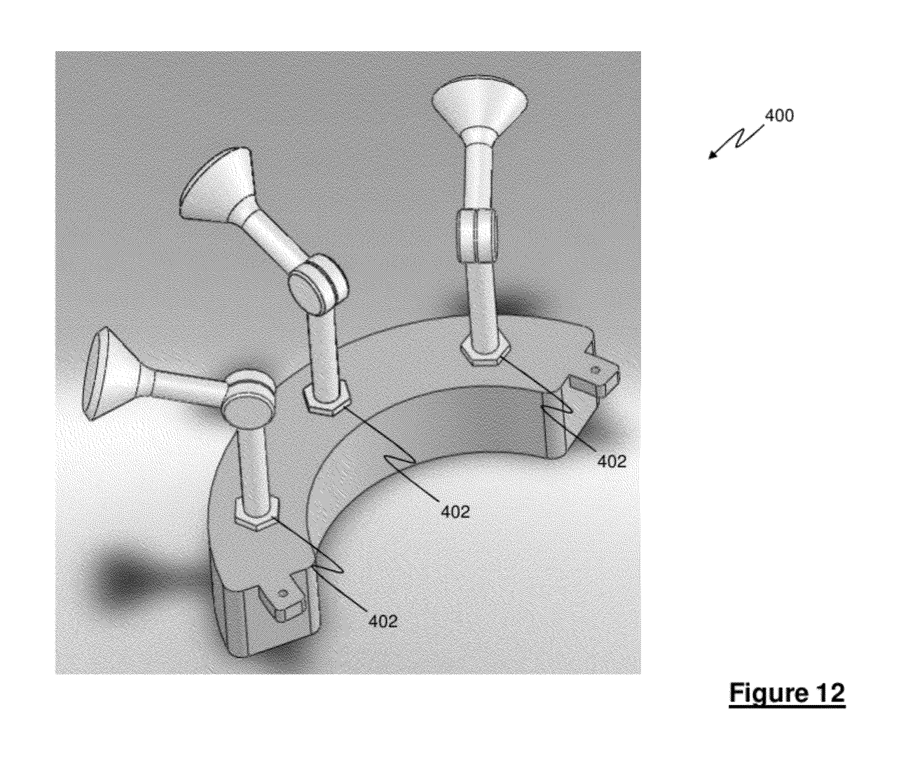

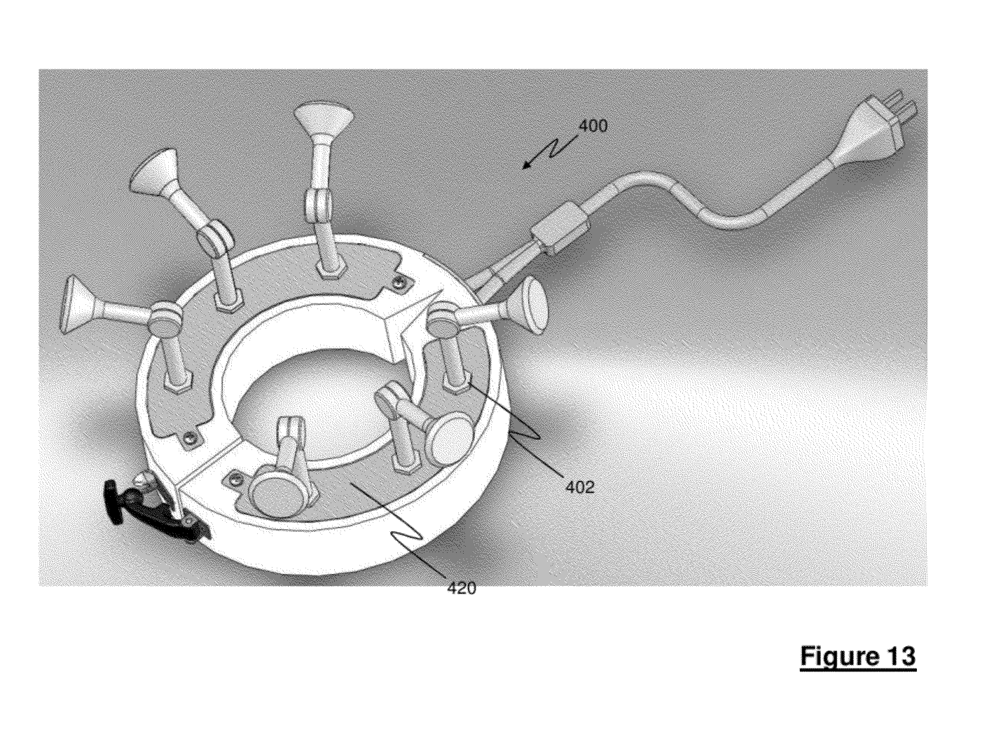

It should be appreciated that the first half circle 414 and/or second half circle 416 may include one or more electrical fixture/receptacles 402, and/or other type of receptacles for allowing other devices to be connected. It is contemplated that each of these electrical fixture/receptacles 402 may be removable and/or replaceable on their own without having to replace the whole module 420. This would advantageously allow other devices to be connected to the EPD device 400. One such example is shown in FIG. 12 and FIG. 13.

It should be appreciated that the first half circle 414 and/or second half circle 416 and the removable receptacle/fixture module 420 may be configured to allow the removable fixture/receptacles modules 420 to be connected to the power cord 404 by simply inserting the removable receptacle/fixture modules 420 into a module cavity 418 (See FIG. 10) of the first half circle 414 and/or second half circle 416. In accordance with the invention, the module cavity 118 is configured to securely contain the receptacle/fixture module 420 and to allow the receptacle/fixture module 420 to electrically interface with the power cord 404. Thus, each of the module cavities 418 may include a power receptacle and the removable receptacle/fixture modules 420 may include a power plug, such that when the removable receptacle/fixture modules 420 are located within the module cavities 418, the power plug electrically connected to the receptacle/fixture inside the module cavity 418.

For example, in one embodiment the receptacle/fixture modules 420 may be associated with the EPD device 400 simply by plugging the receptacle/fixture modules 420 into the first half circle 414 and/or the second half circle 216. In this embodiment, a female-type receptacle (such as a NEMA 5-15R) may be located in the bottom portion of the receptacle/fixture module 420, where the female-type receptacle is connected to the electrical fixture/receptacles 402. Additionally, a male-type plug may be located inside of the device module cavity, wherein the male-type plug is connected to the power cord 404. Accordingly, when the receptacle/fixture module 420 is inserted into the device module cavity, the male-type plug of the EDP device 400 is inserted into the female-type receptacle of the receptacle/fixture module 420.

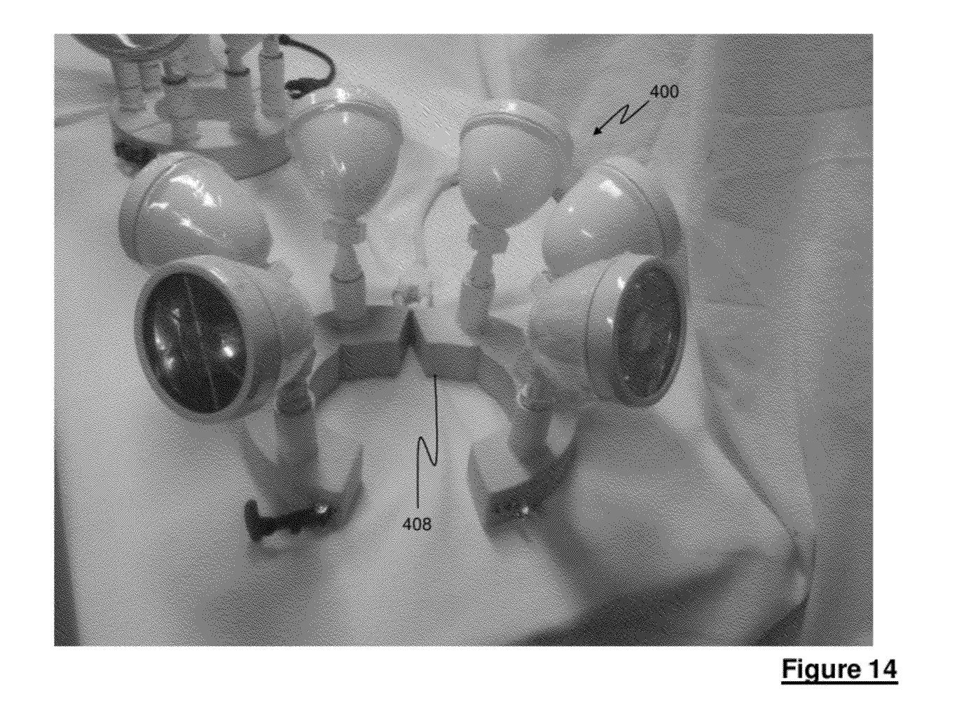

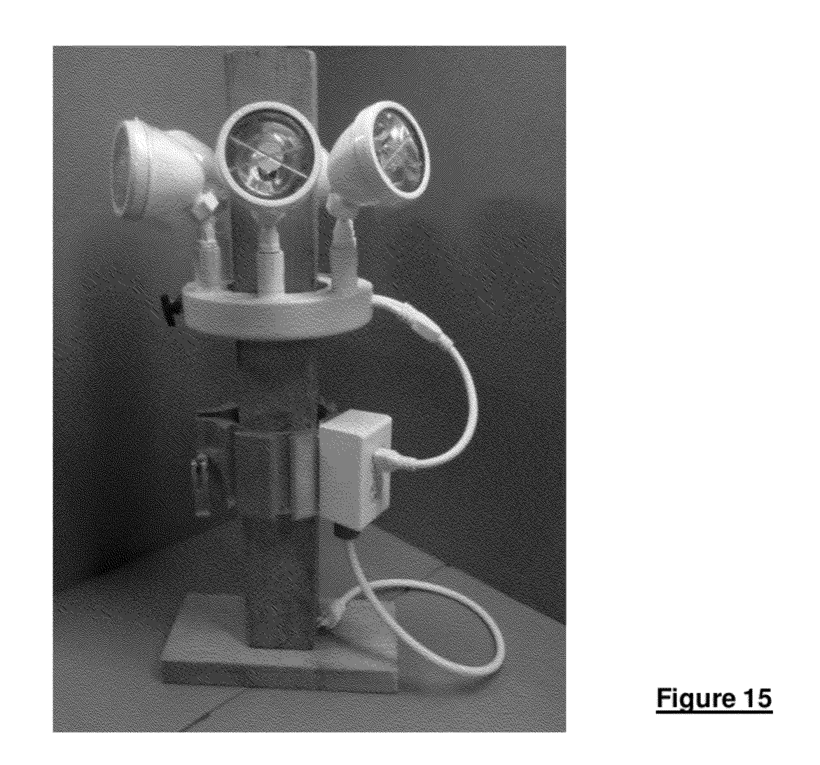

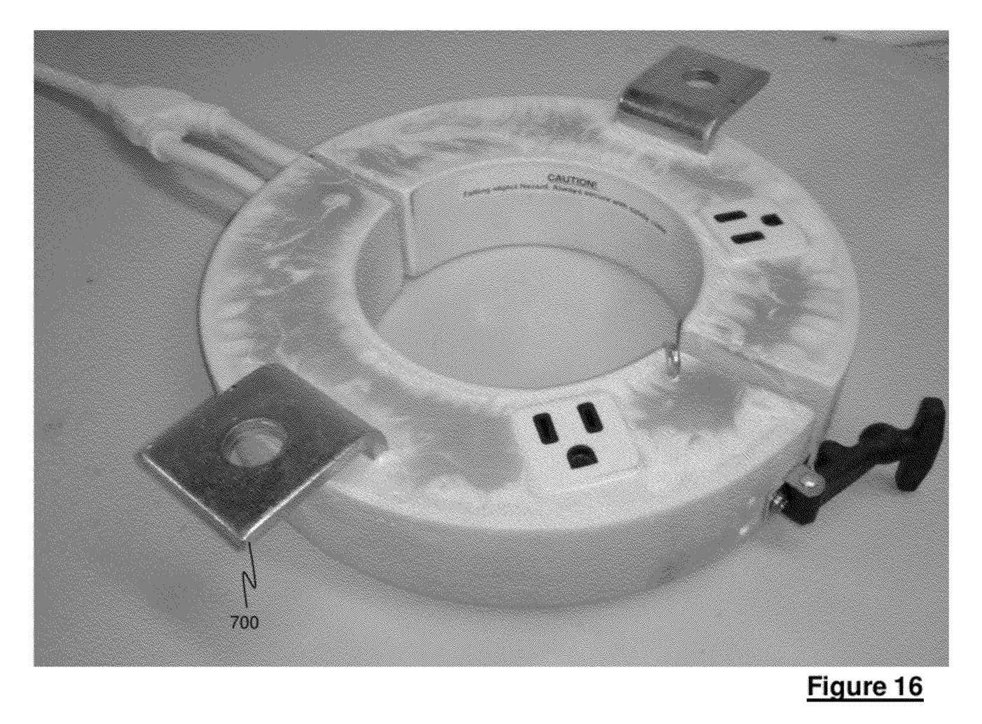

Moreover, It should be appreciated that although the EPD device 400 and/or the device cavity 408 is shown as being substantially circular (cylindrical) in shape, the electrical power distribution device 400 and/or the device cavity 408 may any shape desired, such as for example square (rectangular), circular, triangular, octagonal, star shaped, etc. . . . Additionally, it is contemplated that an insert that may be securely associated with the EPD device 400 to be located with the device cavity 408 may be provided where the insert would allow the device cavity 408 to be configured as any shape desired. This would advantageously allow the electrical power distribution device 400 to be attached to any shaped pole. One such example is shown in FIG. 14 and FIG. 15. It should be appreciated that if an insert is used to shape the device cavity 408, the insert may be securely associated within the device cavity 408 of the electrical power distribution device 400 via any securing device or method suitable to the desired end purpose. Furthermore, referring to FIG. 16, it is contemplated that EPD 100, 400 may include one or more mounting brackets 700 to allow one or more additional electrical devices such as PAR lights to be connect thereto.

In accordance with still yet another embodiment, it is contemplated that the EPD device 100 may be configured to include lights (such as Laser lights or colored lights) that move in multiple dimensions. For example, the electrical receptacles 102 may be configured with lighting elements that include an electric motor that cause the lighting elements 102 to move side-to-side, up/down and in a circular fashion. The motor may be controllable via a processing device that is disposed internal or external to the EPD device 100. Accordingly, the EPD device 100 may include connectors that connect the processor to the electric motor to operate and control the motor. It should be appreciated that the wiring to control the motors may be encapsulated in a similar fashion to the wiring for powering the electrical receptacle 102 or the motors may be controlled via a wireless connection.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

I claim:

1. An electrical power distribution device, comprising:
a device housing defining a device cavity and having a first housing portion movably connected to a second housing portion via a hinge member, wherein the first housing portion and second housing portion are configurable between a first configuration and a second configuration;
a power connection cord; and
at least one electrical receptacle, wherein the at least one electrical receptacle is associated with the device housing and electrically connected with the power connection cord.

2. The electrical power distribution device of claim 1, wherein when in the first configuration, the end of the first housing portion and the second housing portion are located proximate to each other.

3. The electrical power distribution device of claim 2, further comprising a latching device configured to securely associate the end of the first housing portion with the end of the second housing portion when in the first configuration.

4. The electrical power distribution device of claim 2, wherein each of the first housing portion and the second housing portion are shaped as a half-circle such that when the device housing is configured in the first configuration the device cavity is substantially circular.

5. The electrical power distribution device of claim 1, further comprising an device cavity insert, wherein the device cavity insert defines an insert cavity configured to contain a mounting structure.

6. The electrical power distribution device of claim 1, wherein the at least one electrical receptacle includes a plurality of electrical receptacles associated with at least one of the first housing portion and the second housing portion.

7. The electrical power distribution device of claim 1, wherein the at least one electrical receptacle is removably associated with at least one of the first housing portion and the second housing portion.

8. The electrical power distribution device of claim 1, wherein at least one of the first housing portion and the second housing portion includes an electrical receptacle cavity configured to removably contain an electrical receptacle and including a housing power connector connected to the power cord.

9. The electrical power distribution device of claim 8, wherein the at least one electrical receptacle is sized and shaped to be removably locatable within the electrical receptacle cavity and includes a receptacle power connector configured to electrically connect with the housing power connector when located within the electrical receptacle cavity.

10. The electrical power distribution device of claim 1, wherein the at least one electrical receptacle includes at least one of an electric power receptacle, a lighting fixture and/or a Laser light fixture.

11. An electrical power distribution device, comprising:
a device housing, wherein the device housing is shaped to define a device cavity and includes a first housing portion and a second housing portion, wherein the first housing portion is connected to the second housing portion via a hinge member such that the first housing portion and the second housing portion rotate relative to each other between a first configuration and a second configuration, and wherein the device cavity is configured to allow the device housing to wrap around a support structure;
a connecting member;
a power connection cord; and
at least one electrical receptacle associated with the device housing and electrically connected with the power connection cord.

12. The electrical power distribution device of claim 11, wherein when in the first configuration, the end of the first housing portion and the second housing portion are located proximate to each other.

13. The electrical power distribution device of claim 12, wherein the connecting member is a latching device configured to securely associate the end of the first housing portion with the end of the second housing portion when in the first configuration.

14. The electrical power distribution device of claim 12, wherein each of the first housing portion and the second housing portion are shaped as a half-circle such that when the device housing is configured in the first configuration the device cavity is substantially circular.

15. The electrical power distribution device of claim 11, further comprising an device cavity insert, wherein the device cavity insert defines an insert cavity configured to contain a mounting structure.

16. The electrical power distribution device of claim 11, wherein the at least one electrical receptacle includes a plurality of electrical receptacles associated with at least one of the first housing portion and the second housing portion.

17. The electrical power distribution device of claim 11, wherein the at least one electrical receptacle is removably associated with at least one of the first housing portion and the second housing portion.

18. The electrical power distribution device of claim 11, wherein at least one of the first housing portion and the second housing portion includes an electrical receptacle cavity configured to removably contain an electrical receptacle and including a housing power connector connected to the power cord.

19. The electrical power distribution device of claim 18, wherein the at least one electrical receptacle is sized and shaped to be removably locatable within the electrical receptacle cavity and includes a receptacle power connector configured to electrically connect with the housing power connector when located within the electrical receptacle cavity.

20. The electrical power distribution device of claim 11, wherein the at least one electrical receptacle includes at least one of an electric power receptacle, a lighting fixture and/or a Laser light fixture.
